(19) United States
(12) Patent Application Publication
(10) Pub. No.: US 2002/0144278 A1
(43) Pub. Date: Oct. 3, 2002

(54) System for transmitting desired digital media and audio signals in a 3-dimensional holographic format via computer network

(76) Inventors: Edwin Daniel Pratts, Lakewood, NJ (US); Susan Lyn Pratts, Lakewood, NJ (US)

Correspondence Address: Edwin Daniel Pratts,, Susan Lyn Pratts, 500 Prospect St, Lakewood, NJ, 08701, US

(21) Appl. No.: 10/055,856

(22) Filed: Jan. 25, 2002

Related U.S. Application Data
(63) Continuation of application No. 09/361,385, filed on Jul. 26, 1999.

(51) Int. Cl. H04N 7/173; G06F 15/16

(52) U.S. Cl. 725/93; 725/87; 709/231

(57) ABSTRACT

A method for transferring desired digital media and audio signals in a three dimensional holographic format. The method comprises the steps of forming a connection through high-speed telecommunications lines or high-speed telecommunications signals (satellites) between a first memory of a first party and a second memory of a second party. The first memory has the desired digital media and audio signals. Then, there is the step of selling electronically by the first party to the second party through the high-speed telecommunication lines or high-speed telecommunications signals, the desired digital media and audio signals in the first memory. There is then the step of transferring the desired digital media and audio signals from the first memory of the first party to the second memory of the second party through the telecommunications lines or telecommunications signals while the second memory is in possession and control of the second party. Additionally, there is a system for transferring the digital media and digital audio signals.

This application is a continuation of application Ser. No. 09/361,385 filed on Jul. 26, 1999, which is in continuation of Service and Trademark Ser. No. 75/366,076, which was Publicized on Oct. 5, 1999, in the Official Gazette.

### FIELD OF THE INVENTION

The present invention is related to a system and associated method for the electronic sales and distribution of digital audio and digital media signals, and more particularly, to a system method which a user may purchase or view and receive digital audio and digital media signals from any location which a user has access to telecommunications lines or telecommunications signals and receive the transmission in broadcast quality with full screen capability in a 3-Dimensional Holographic format.

### BACKGROUND OF THE INVENTION

The two basic mediums (hardware units) of motion pictures and or medias along with sound being transferred simultaneously greatly restricts the transferability of media's and results in a variety of insufficiencies. The client end user must have the ability to use high band width or high speed internet access in order for the transmission to be received in broadcast quality with the full screen capability, in a holographic format. Which means that the client end user must have the capability of high-speed telecommunications lines or high-speed telecommunications signals (satellites).

CAPACITY: The individual hardware units as cited above are limited but not restricted to the amount of digital media data or digital movie data that can be stored on each unit.

MATERIALS: The materials used in the hardware units are subject to damage and deterioration during normal operations, handling, and exposure to the elements. The materials for this invention will be listed in the Description Of The Embodiment.

SIZE: The physical size of the hardware units imposes the quantity of hardware units which can be housed for playback in confined areas such as in automobiles, boats, planes, etc. The storage size to hold this digital data will always be limited, but without limitation as the technology grows.

RETRIEVAL: Hardware units have the remote ability to play, in a sequence selected by the user, movies and media's. For example, if the user wants to watch 5 different media's and then a movie, the user would spend a little time making selections and the media and movie would play remotely in the order that has been picked, from the hardware units.

SALES AND DISTRIBUTION: Prior to final purchase, the hardware units would transfer the information and selections for the user to view and make sure the selections are correct. Then, in a secured site, they would pay the fee and the medias and/or movies will playback for them at their convenience, at their remote location.

Once a selection has been made the digital media and digital audio will be transferred simultaneously through high-speed telecommunications lines or high-speed telecommunication signals (satellites). The media or movie and audio signals will project with full screen capability, without the download time, (which is presently being used today), with selected functions to play, rewind, fast forward, pause, zoom, and other features that will enhance the visual affect of the digital viewing.

QUALITY: Until the recent invention of Video Streaming, there hasn't been a way to send such stored data information through a Global Computer Network. Through years of research the technology has changed thus providing this data to be sent at a faster speed creating better digital imaging. Through our invention, the end user will be able to capture broadcast quality, 3-Dimensional holographic viewing with full screen capability, without downloading (which causes the data to buffer or regenerate the information being sent). Instead, it will be sent and viewed as the data transfers at a much higher speed through a Virtual Private Network causing the imaging not to be distorted, or have loss of color and have digital broadcast quality or better.

COPYRIGHT PROTECTION: Since the invention of video streaming, strict control and enforcement of copyright laws have proved difficult and impossible with downloadable video streaming. Additionally, the recent invention of digital camcorders now jeopardize the electronic copyright protection of transferring medias through the internet, which respectfully means, if it can be transferred, it can be copied. However, with the use of a Virtual Private Network, there will be no download and the medias/movies will be streamed directly and have lesser chances of being copied.

Thus, as is apparent from the above discussion, the inflexible form in which the movies or medias are purchased from the end user, and the distribution channels of the movies and medias, requires the end user to go to a location to purchase the streaming of movies or medias, and not necessarily be able to purchase the movies or medias desired to be viewed, in a sequence the end user would like to view them.

Accordingly, it is an objective of this invention to provide a new and improved methodology/system to electronically sell and distribute Digital Movies/medias with audio. A further objective of this invention is to provide a new and improved methodology to electronically store and retrieve Digital Movies and medias using software plugins to view them in a holographic format.

Another objective of this invention is to provide a new methodology or system that can manipulate, sort, select, and store for future viewing Digital Movies or medias as well as prevent unauthorized, electronic copying of quality Digital Movies or media.

### SUMMARY OF THE INVENTION

Briefly, this invention accomplishes the above-cited objectives by providing a new and improved methodology/system of electronically sales, distribution, storage, manipulation, retrieval, playback, and copyright protection of Digital Movies/medias. The high-speed transfer of Digital Movies/medias as described by this invention is stored on hard disks, thus eliminating the need to unnecessarily handle movies, medias or dvd on a regular basis. This invention recalls stored movies/medias for playback as selected/programmed by the user.

This invention can easily and electronically sort stored movies/medias on many different criteria such as, but not limited to, film category, movie directors, filmmakers, movie stars, producers, etc. Any method of electronically transferring Digital Movies/medias by means of this invention is intended to comply with all copyright laws and restrictions and any such transfer is subject to the appropriate authorization by the copyright holder. In as much Digital Movies/medias is software files and this invention electronically transfers and stores such movies/medias, electronic sales and distribution of the movies/medias can take place via fiber optic and high speed internet access through land and air onto another receiver or computer. This new methodology/system of movies/medias sales and distribution will greatly reduce the cost of goods sold and will reduce the lag time between movie/media creation and movie/media marketing from weeks down to hours.

The present invention is a system for transmitting desired Digital Media or Digital Audio signals stored on a first memory of a first party to preferably a second memory of a second party. The system comprises means or mechanism for electronically transferring the desired digital media or digital audio signals preferably via telecommunications lines to the first party from the second party. Moreover, the system preferably comprises means or mechanism for connecting electronically via telecommunications lines or signals the first memory preferably with the second memory such that the desired digital media or digital audio signals can pass there between.

Additionally, the system comprises means or mechanism for transmitting the desired digital medias/movies or digital audio signals from the first memory with a transmitter in control and in possession of the first party to a receiver preferably having the second memory while the receiver is in possession and in control of the second party. The receiver is placed at a second party location determined by the second party. Preferably, there is also means or mechanism, but not limited to, for viewing the digital media/movie or digital audio signal in the second memory. Further objectives and advantages of this invention will become apparent as the following description proceeds and the particular features of novelty which characterize this invention will be pointed out in the claims annexed to and forming a part of this declaration.

### BRIEF DESCRIPTION OF THE DRAWINGS

For a better understanding of this invention, reference should be made to the following detailed description, taken in conjunction with the accompanying drawings, in which:

FIG. 1. Is a pictorial flow chart which may be used in carrying out the teachings of this invention for the purposes of electronic sales, distribution, storage, manipulation, retrieval, playback, and copyright protection of Digital Media/Movies in conjunction with Digital Audio, and

FIG. 2. Is a pictorial flow chart, which may be used in carrying out the teachings of this invention for the purposes of electronic sales, manipulation, retrieval, and playback of Digital Media/Movies in conjunction with Digital Audio.

### DESCRIPTION OF THE PREFERRED EMBODIMENT

Referring now to the drawings wherein like reference numerals refer to similar or identical parts throughout the several views, and more specifically to figure thereof, there is shown.

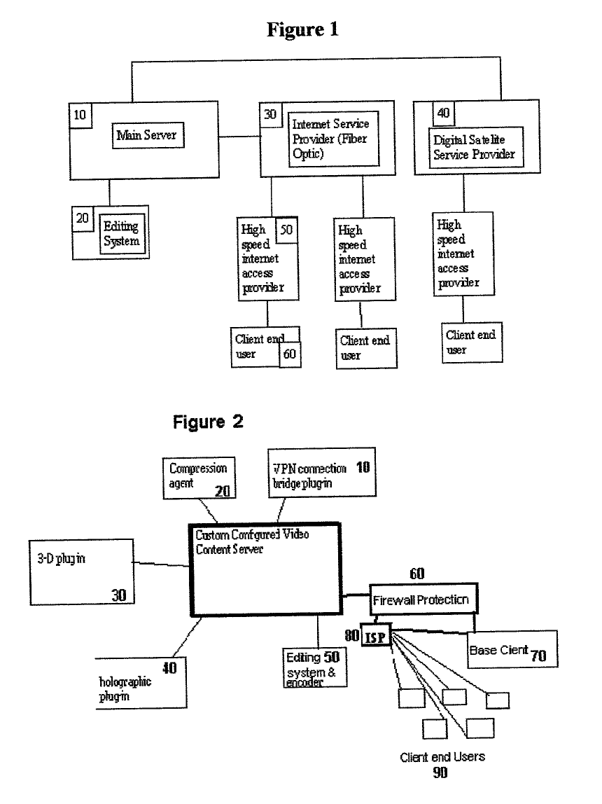

Referring now to the FIG. 1., this invention preferably is comprised of the following:

10 Main Server—which consist of the main hard drive in which all of the digital media is retrieved and stored electronically for a fee and then sent out to the second party who is requesting this digital media.

20 Editing system—which is connected to the main server for editing and compressing files into the main server.

30 Fiber Optic Telecommunications lines in which the digital media will transfer at a super high speed and retrieved by a high speed Internet provider.

40 Digital Satellite Service Provider—which can retrieve the digital media and audio signals and transfer the digital signals to a high speed internet access provider and/or end user.

50 High Speed Internet Access Provider—who has a minimal speed of at least 560 kbps in which the digital data is transferred from the first party and then received by the second party using the same bandwidth provided by the provider. This is where the client end user will receive the final transmission prior to viewing the media being transferred.

60 Client End User—which will be the one retrieving the information requested by the main server.

The Main Server (10) of the first party or authorized agent to electronically sell and distribute the copyrighted Digital Media/Movies and Digital Audio is the originating source of the Digital data in configuration as outlined in FIG. 1. In the Main Server, will also be plugins for the second party to download onto their hard drives to view the new formatted version of holographic format

The Editing System (20) of the authorized agent is the means of digitally transferring the data from the main server onto a smaller hard drive for the digital data to be edited and formatted correctly and compressed to be stored back onto the main server (10), in which is necessary for the client end user to select from.

Internet Service Provider (ISP)(Fiber Optic) (30) will transfer the desired digital media through telecommunication lines from the main server to the High speed access provider and/or the client end user. The digital data will be transferred from the main server (10) to the Internet Service Provider (ISP) through the use of high-speed telecommunication lines, (e.g. Fiber Optic transmission lines).

Satellite Service Provider (40) will transfer the desired digital media from the main server through the use of high speed signals to remote satellites that will then transfer the digital signals to either the client end user and/or another satellite in the area of the user, in which the client end users receiver will have the capability to capture the signals for viewing the desired digital media at the users request, in the desired three dimensional holographic format.

High Speed Access Provider (50)(Cable, T1, T3, DSL, etc.) will be transferring the digital media through high speed telecommunication lines from the Internet Service Provider (30) to the client end user through either fiber optic telecommunication lines and/or high speed copper wires to the client end user, in which the client end user will be able to view the desired digital media at their request, in the desired three dimensional holographic format.

Client End User (60) will be connected to the high-speed access provider through high-speed telecommunication lines and/or high speed telecommunications signals. The client end user will be in charge of the digital media selected from their remote location when selecting and receiving the digital media transmission through high-speed telecommunication lines and/or signals. The client end user will first search for their selection and then make their selection of the desired digital media. The selected digital media will then be transferred to the client end user through a Virtual Private Network and/or Point-to-Point Tunneling Protocol (PPTP), or any other source of transferring the desired digital media in its holographic format, which will be sent directly to the user without having to download the digital data/media to its hard drive/disk. The digital transmission will be viewed instantly and accordingly to the reception of the client end user. The client end user will now have total charge of the desired digital media and may use special features and/or plug-ins, and/or accessories to view the desired digital media in its 3-Dimesional holographic format.

Now referring to FIG. 2

The items in the figure are not in a sequence order. For viewing the format, they are hardware and software that is part of the custom configuration in which is needed to provide the desired digital media in the 3-D holographic format

Custom Configured Video Content Server——The video content server is customed configured with hardware and software to provide convenience with the client end user and the Base Client. The server is designed to permit the user to use programs that will enable the user to view a selection of media in which they are searching for. This will be done through search engines designed to search our database by subject, author, producer, director, title, etc. Once the selection is made the server will hold that search and store it for the client to have transmitted to their remote location at the desired time selected by the client end user. Our server will also have the capabilities to receive digital media from our base clients and compress the digital media and encode it to the proper format for viewing the desired digital media, which will be discussed later in this section. The digital media will then become a file storable on our server which will have its own random number in which it will be stored in our library in a Dewey Decimal configuration. This will make search criteria more simple and precise in selections chosen by the client end user.

Virtual Private Network Connection (VPN) or Point to Point Tunnel Protocol (PPTP)——This is a connection to allow the user to receive the digital media directly from our server to their location on a single network. The client end user will have a connection from their Internet Service Provider and/or have a connection directly to our server through our high speed telecommunication provider in order to receive the transmission in a two step process, eliminating the traffic of the internet, which will reduce the transmission that will be received from the client end user and/or from our server.

Compression agent——will be used to compress the digital media from its original content format to the desired content format that will be needed to be viewed from the client end user. This compression agent will also be used to transfer the digital media into a format that will prevent unauthorized reproductions of the copyrighted materials.

3-D plug-in is a software that is needed to be downloaded to the client end users receiver, from our web site, in order to view the desired digital media content in the 3-D format in which it is being transmitted in.

Holographic plug-in is a software that is needed to be downloaded to the client end users receiver, from our web site, in order to view the desired digital media content in the holographic format in which it is being transmitted in. With the holographic plug-in there will be an additional accessory that must be used on the client end users viewable monitor. This accessory is a screen that will be mounted onto the screen by either the client end user and/or the manufacturer of the receiver in which the image will appear to be projected off the monitor to provide a holographic image. This along with the software will enhance the digital imaging into a three dimensional viewable format.

Editing System and encoder are sources of hardware and software designed to add, remove, enhance, edit and encode the digital media files into the proper code for formatting the media to its desired degree. The digital media will go through the editing process prior to being stored onto the main server to assure the best quality in digital video streaming from our server. By encoding the copyrighted materials that will be stored on our servers, this will prevent unauthorized reproduction of the materials being delivered to the client end user.

Firewall protection will be used to ensure the protection of our client Base and the copywritten materials that will be stored on our servers. Only registered members of our service will be allowed to enter into our data banks to view the desired digital media in which they are searching for.

Base Client will be the actual provider of the media in which will be viewed through our service. They will transmit their video content to us through our virtual private network and/or Point-to-Point Tunnel Protocol, to provide to their clients the service of 3-D Holographic. The video content can be transferred to us through many ways. Through our own network, it can be transferred in different formats that video content is transferred, such as FTTP or digital file formats. Or it can be delivered via postal service in beta format, vhs format, digital format or dvd format. Either way the video content is delivered we will be able to transfer the video content into the desired digital 3-D holographic format in which we will provide to the client end user. The Client Base will be charged from our company either electronically and/or via postal service, fees in some or all of the following areas: a storage fee, a transfer video content fee, a video streaming fee and a membership fee, among any other fees that may be encountered. Some of the other fees that may be encountered are: taxes where applicable, increase storage and expanded services, among any other fees that may occur and/or change in the future.

ISP/Internet Service Provider will be the source of direction from the client end user to our facility in which the desired media will be streamed from. The ISP will have to have the proper bandwidth in order to provide to its client the true clarity in which we will provide.

Client end user will be responsible for the proper plug-ins, membership registration, media information in which they seek, minimum requirements to view the content, any accessories if needed and/or the telecommunication services in order to capture the desired digital 3 D_holographic format.

This concludes any information regarding this Utility Patent, if there are any further questions please contact Edwin Daniel Pratts at 732-364-2004 or 500 Prospect Street Lakewood, N.J. 08701.

What is claimed is:

1. A system for transmitting desired digital media and audio signals in a 3-Dimensional holographic format having at least one custom configured video server including a digital video data storage device for storing digital video data and a streaming unit reading the digital video data from the digital video data storage device to perform a digital video streaming process on the digital video data, said system for transmitting desired digital media and audio signals in a 3-Dimensional holographic format providing a subscriber with a 3-Dimensional digital video-on-demand service at a request from the subscriber, comprising:
a custom management unit managing the process of each digital video server and determining if spare capacity exists on the digital video server;
a full screen digital-video-on-demand service with no downloading or buffering unit providing a requested digital video data through a full screen digital video-on-demand service which broadcasts the digital video data stored in the digital video data storage device along through high speed telecommunication signals, wherein the 3-Dimensional holographic digital video data is played upon a request of the subscriber;
a service switch determining unit which determines, upon receipt of a request, to watch the selected digital video from the subscriber, whether a selection of the requested video is to be streamed in the full-video-on-demand service or to be downloaded by the distributor of the digital content, depending on management information managed by said custom configured digital video/content server or whether spare capacity exists on the client end user.
a broadcast unit broadcasting the requested live digital video by said full video-on-demand service providing unit for the subscriber according to a determination result from said service switch determining unit.

2. The system for transmitting desired digital media and audio signals in a 3-Dimensional holographic format according to claim 1, wherein
said load state management unit manages a number of digital video/content programs being processed by each digital video server; and
said service switch determining unit switches a service for the subscriber from the full-video-on-demand service to the broadcast-on-demand service when the requested broadcast is newly broadcasted and the number of the video programs managed by said load state management unit exceeds a predetermined bandwidth.

3. The system for transmitting desired digital media and audio signals in a 3-Dimensional holographic format according to claim 1, wherein
said load state management unit manages a number of video programs being accessed by the streaming unit in each video server and stored in the video data storage device; and
said service switch determining unit switches a service for the subscriber from the full-video-on-demand service to the broadcast-on-demand service when the requested video is newly broadcast and the number of the video programs managed by said load state management unit exceeds a predetermined bandwidth.

4. The system for transmitting desired digital media and audio signals in a 3-Dimensional holographic format according to claim 1, wherein
said load state management unit manages the number of current subscribers to each video whose data is stored in the digital video data storage device in each custom video server; and
said service switch determining unit switches a service for the subscriber from the full-video-on-demand service to the live broadcast-on-demand service when the requested video is newly broadcast and the number of the subscribers managed by said load state management unit exceeds a predetermined threshold.

5. The system for transmitting desired digital media and audio signals in a 3-Dimensional holographic format according to claim 1, further comprising:
a subscriber number management unit managing a number of subscribers watching the live broadcast-on-demand service each video whose data is stored in the digital video data storage device in each video server, wherein
said broadcast unit stops broadcasting the video according to management information managed by said subscriber number management unit when it is determined that no subscriber is watching the video being broadcast in the live broadcast-on-demand service.

6. The system for transmitting desired digital media and audio signals in a 3-Dimensional holographic format according to claim 1, further comprising: a title/author selection control unit providing an interactive inputting operation for selecting a title of a video or media content requested and displayed on a monitor of a receiving terminal device on a subscriber side in a same format in the full-video-on-demand service and the live broadcast-on-demand service.

7. The system for transmitting desired digital media and audio signals in a 3-Dimensional holographic format according to claim 1, further comprising:
a subscriber storage unit storing a list of subscribers when a video is to be broadcast after being switched to the broadcast-on-demand service by said service switch determining unit and when another subscriber issues a request to watch the video during the actual broadcast of the video after switching to the live broadcast-on-demand service, wherein
said broadcast unit provides said list of subscribers stored in said subscriber storage unit with the video in the live broadcast-on-demand service.

8. The system for transmitting desired digital media and audio signals in a 3-Dimensional holographic format according to claim 7, wherein
said subscriber storage unit stores the list of subscribers in the order in which requests are received.

9. The system for transmitting desired digital media and audio signals in a 3-Dimensional holographic format according to claim 1, further comprising:
a subscriber-demand-by-title storage unit receiving service switch information from said service switch determining unit and storing the number of subscribers of a video whose data is stored in the video data storage device of each digital video server separately for the full-video-on-demand service and the live broadcast-on-demand service.

10. A system for transmitting desired digital media and audio signals in a 3-Dimensional holographic format having at least one digital video server including a digital video data storage device for storing digital video data and a streaming unit reading the digital video data from the digital video data storage device to perform a video streaming process on the digital video data, said system for transmitting desired digital media and audio signals in a 3-Dimensional holographic format providing a subscriber with a full screen digital video-on-demand service with no downloading or buffering at a request from the subscriber, comprising:
a load state management unit managing a load in a process of each digital video server and determining if spare capacity exists on the digital video server;
a full-video-on-demand service providing unit providing a requested digitalvideo data through a full-video-on-demand service which broadcasts the digital video data stored in the digital video data storage device through high speed telecommunication signals, wherein the broadcasted digital video data is played upon in a 3-Dimensional holographic format by the request of the subscriber;
a live broadcast-on-demand service providing unit providing said requested digital video data through a live broadcast-on-demand service which broadcasts the digital video data stored in the digital video data storage device along high speed telecommunication signals at predetermined time intervals;
a first service switch determining unit determining, upon receipt of a request to watch a video from the subscriber, whether a broadcast of the requested video is to be serviced in the full-video-on-demand service or the live broadcast-on-demand service depending on management information managed by said load state management unit including whether spare capacity exists on the custom configured digital video server as determined by said load state management unit;
a second service switch determining unit determining, upon receipt of a request to download a video from the provider, whether a broadcast of the requested video is to be downloaded by the specific user
a broadcast unit broadcasting the requested video by said full-video-on-demand service providing unit or said live broadcast-on-demand service providing unit to the subscriber according to a determination result from either said first or second service switch determining unit.

11. The system for transmitting desired digital media and audio signals in a 3-Dimensional holographic format according to claim 1, further comprising:
a service information broadcast unit broadcasting various service information to the subscriber after switching by said service switch determining unit a broadcast of a video from the full-video-on-demand service to the live broadcast-on-demand service until an actual broadcast of the video starts.

12. A system for transmitting desired digital media and audio signals in a 3-Dimensional holographic format, comprising:
determining, at a request from a subscriber for a full video-on-demand service, whether or not video data can be provided in a full-video-on-demand service which broadcasts the digital video data stored in the digital video data storage device along high speed telecommunication signals, wherein the broadcasted digital video data is played upon a request of the subscriber; and
providing the subscriber has the capabilities to have the proper bandwidth in order to retrieve the desired full digital video-on-demand service.

13. A system for transmitting desired digital media and audio signals in a 3-Dimensional holographic format to transmit video programs to subscribers having at least one digital video server, comprising:
a load state management unit to determine a load and whether any excess capacity exists on said video server by monitoring the number of video programs being streamed and the number of subscribers viewing each of the video programs being delivered;
a full-video-on-demand service providing unit providing a requested digital video data through a full-video-on-demand service which broadcasts the video data stored in the video server along a high speed telecommunication signal wherein the broadcasted video data is played upon a request of a subscriber;
a live broadcast-on-demand service providing unit providing said requested digital video data through a live broadcast-on-demand service which broadcasts the digital video data stored in the digital video server along plural channels for live video on demand at the predetermined time;
a broadcasting unit to transmit the live video program immediately along the one channel for full digital video on demand when said service switch determining unit determines to provide the live video program via the full-video-on-demand service and to broadcast the video program in the time period, the said service switch determining unit determines to provide the video program in the live broadcast-video-on-demand service.

14. A method of distributing digital video data over a digital video server, comprising:
receiving a program request from a subscriber;
determining whether spare capacity exists on the video server to deliver the program requested to the subscriber in full screen 3-Dimensional holographic video on demand;
transmitting a requested digital video data, corresponding to the program, stored in the video server immediately to the subscriber along one channel for full screen 3-Dimensional holographic video on demand when spare capacity exists on the video server of the subscriber;
informing the subscriber of a viewing time for the program in live broadcast-on-demand when spare capacity does not exist on the video server of the subscriber, the viewing time included in plural viewing times separated by corresponding predetermined time intervals;
determining if the subscriber agrees to receive the program at the viewing time in near video on demand when spare capacity does not exist on the video server of the subscriber; and broadcasting said requested video data stored in the video server along plural channels for near video on demand upon arrival of the viewing time when the subscriber agrees to receive the program in near video on demand at the viewing time.

15. A method of receiving digital video data to the digital video server through high-speed telecommunication signals comprising;
an automatic retrieving system that allows the digital video content to be received through the data network and to be accounted for by the distributor connecting to its dedicated server.
A system that acknowledges the digital video being transferred and stored onto its dedicated server with time stamp and date received.

16. A system that counts the amount of digital videos being received by the distributor comprising;
A system that holds and stores in digital data formats such as megabytes to gigabytes, to acknowledge the distributor of the amount of server space that has been accepted and stored on the digital video server that is dedicated to the individual distributor.

17. A system that stores and sends 3-Dimesional holographic digital video data to be streamed to the subscriber through the use of high-speed telecommunication signals connected into the digital video server and network.
